(19) United States
(12) Patent Application Publication
(10) Pub. No.: US 2003/0065534 A1
(43) Pub. Date: Apr. 3, 2003

(54) Health care management method and system

(76) Inventor: Michael J. McCartney, Richmond Hill (CA)

Correspondence Address: Mr. David J. Greer, c/o Ridout & Maybee LLP, Suite 2400, One Queen Street East, Toronto, ON, M5C 3B1, CA

(21) Appl. No.: 09/969,459

(22) Filed: Oct. 2, 2001

(51) Int. Cl. G06F 17/60

(52) U.S. Cl. 705/2

(57) ABSTRACT

A method for determining resource consumption information for a subject health care provider using resource consumption information of at least one other health care provider, including (a) determining, based on information obtained from the at least one other health care provider, a relative resource weight for a health care resource for a patient group based on consumption of the health care resource by the patient group relative to consumption of the health care resource by a sample group; and (b) determining, for the subject health care provider, an estimated consumption of the health care resource for the patient group by adjusting consumption information of the subject health care provider based on the determined relative resource weight.

### BACKGROUND OF INVENTION

The present invention relates generally to the field of health data processing systems, and more particularly to systems providing case costing and resource profiling for health care management purposes.

The cost of and demand for health care services has increased substantially over recent years, and will likely continue to increase further as the population grows and as the average age of the population shifts demographically higher. Thus, the demand and expectation of resource efficient care is growing. This has created a need for health care planning and management tools, and a great deal of literature and research has been directed towards the development of such tools. By way of example, the inventor of the present invention has obtained U.S. Pat. No. 5,778,345 directed towards a health data processing system that evaluates health care provider performance, forecasts health care resource consumption on a macroeconomic scale, and allows for optimized allocation of health care resources.

A subset of health care planning and management pertains to case costing and resource profiling. Case costing requires determining, for a health care provider, the cost of dealing with specific case types. For example a person admitted to a hospital for an appendectomy will typically require expenditure of a number of resources falling within a number of categories. They will generally require operating room time, recovery ward time, drugs, meals, and medical and surgical supplies. In such an example, case costing involves determining the typical costs for the particular hospital of each of these resources individuals and collectively for an appendectomy case type. The case costing may also be done at a higher level for example, the appendectomy could be grouped in with other cases.

One common method of case costing is for a health care provider such as a hospital to track every resource that is used in respect of every patients by predetermined case types. Such systems require an extremely extensive Information Technology system that allows each patient, and the resources used by that patient, to be tracked virtually on a real time basis during the time that the patient is in the care of the health care provider. Such systems are typically very expensive to acquire and maintain.

Health care providers that do not have detailed case cost tracking have traditionally used case cost modelling systems that rely on whatever information is available from the subject health care provider. For example, costs and amounts of resources for individual case types have in the past been estimated by simply allocating tracked costs and amounts to various case types in a manner proportional to a function of the number of such cases and the average length of stay associated with such cases. However, research has indicated that while length of stay can be a useful indicator of total resource use, it can be a misleading indicator for some case types and some resources.

Another approach to case costing has been for one health care provider to borrow the case costing data of another health care provider. However such systems can be inaccurate as they fail to take into account differences in the costs of resources between health care providers in different regions.

Accordingly, there is a need for a health care provider case costing and resource profiling method and system that does not require an extensive and expensive information technology system to implement, yet at the same time permits the unique circumstances of the subject health provider to be accounted for.

### SUMMARY OF THE INVENTION

According to one aspect of the invention, there is provided a method for determining resource consumption information for a subject health care provider using resource consumption information of at least one other health care provider. The method includes (a) determining, based on information obtained from the at least one other health care provider, a relative resource weight for a health care resource for a patient group based on consumption of the health care resource by the patient group relative to consumption of the health care resource by a sample group; and (b) determining, for the subject health care provider, an estimated consumption of the health care resource for the patient group by adjusting consumption information of the subject health care provider based on the determined relative resource weight. According a further aspect of the invention, there is provided a computer program product including a medium carrying program code means to execute this method.

According to still a further aspect of the present invention, there is provided a health care resource profiling system that includes a subject health care provider database containing information quantifying a total use of a health care resource by a master patient group at a subject health care provider during a predefined time period, the master patient group comprising a plurality of case types, and a third party profile database containing information about the use of the health care resource in respect of the case types at a plurality of third party health care providers. The profiling system also includes relative weighting means for determining, based on information in the third party profiles database, case type relative resource weights for each of the case types, each case type relative weight being representative of the average consumption of the health care resource by each of the respective case types relative to consumption of the health care resource by a sample group, and profile generating means for generating a resource use profile for the subject health care provider for the health care resource, the use profile including estimated consumption values of the heath care resource for at least some of the case types, the estimated consumption values being determined by adjusting the information quantifying the total use of the health care resource by the master patient group at the subject health care provider based on the case type relative resource weights.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made, by way of example, to the accompanying drawings which show a preferred embodiment of the present invention, and in which:

FIG. 1 is a block diagram overview of a health care management system in accordance with a preferred embodiment of the present invention.

FIG. 2 is a block diagram of an example of a computer system on which the present invention may be implemented.

FIGS. 3A and 3B illustrate a table of fields in a Patient Record used by embodiments of the system of the present invention.

FIG. 4 illustrates a table showing examples of the type of accounting information tracked by a representative user of the present invention.

FIG. 5 is a flow chart of a process for determining a profile for a Patient Group in accordance with embodiments of the present invention.

FIG. 6 is a flowchart of a process for determining relative resource weightings in accordance with embodiments of the present invention.

FIG. 7 is a flowchart of a process for applying the relative resource weightings to data tracked by a subject health care provider in accordance with embodiments of the present invention.

FIG. 8 is a flowchart of a process for Patient Group case costing and profiling in accordance with embodiments of the present invention;

FIGS. 9 and 10 are schematic illustrations of data tables representing sample information contained in an electronic database for a Master Patient Group of a subject health care provider for illustrating an example of the present invention,

FIG. 11 is a schematic illustration of a data table representing sample relative weights calculated for a Master Patient Group based on third part, data, to illustrate an example of the present invention;

FIG. 12 is a schematic illustration of a data table representing resultant weights calculated for a Master Patient Group, to illustrate an example of the present invention;

FIG. 13 is a schematic illustration of a data table representing an estimated profile for a Patient Group, to illustrate and example of the present invention.

FIG. 14 is a schematic illustration of a data table representing a checking procedure, to illustrate an example of the present invention.

FIGS. 15 to 18 are schematic illustrations of data tables illustrating output examples of an impact report module in accordance with embodiment of the present invention.

### LEXICON

Case Mix Group (CMG) or Diagnostic Related Group (DRG) Classification system which groups the many primary classification codes such as the ICD codes into related clinical service groups. The DRG are employed mainly in the United States for the purposes of prospective payment systems whereas the CMG is employed primarily in Canada. (“CMG” is a trademark of the Canadian Institute of Health Information, Toronto, Ontario). Other countries may use other designations, for example, in the United Kingdom the expression Health Resource Group (HRG) is used. Although they vary somewhat, the grouping systems in different countries generally use the same approach to grouping disease and treatment case types. CMG, DRG, and the phrase “case type” are used interchangeably herein.

Functional Area—a resource category that includes a predetermined group of health resources—examples of Functional Areas include the following: wards special care units, operating room, labs, diagnostic imaging medical supplies, and pharmacy.

Health care provider—A general term for any institution or facility, or any related group of institutions or facilities, providing medical services and treatments.

International Classification of Diseases (ICD)—A coding system widely used by health care providers in North America for the classification of disease manifestations, injuries, symptoms, impairments, (i.e. Diagnoses), Medical Procedures and causes of death. The ICD coding system specifies about 15,000 various categories, and it is usually used in the Patient Record. Structurally, the ICD system is initially divided into Disease and Procedure sections and each of these is further divided in numerous categories and sub-categories further defining disease manifestations and/or medical procedures. Different revisions of the ICD system periodically come out.

Patient Group—a generic term for a diagnostically related grouping of patients; for example, all patients who had a simple appendectomy are in a Patient Group. Another class of Patient Group includes patients of a similar age group with a similar diagnosis; other potential groups also exist, for example all patients with appendectomy and diabetes as a complicating diagnosis—in a statistical sense, a Patient Group is a cohort.

Master Patient Group—a grouping of related Patient Groups. For example “renal program”, a Master Patient Group, includes a number of different Patient Groups that all hall Within the renal program umbrella.

Patient Record—An record compiled during a patient's visit or stay at a health care provider detailing the patient's characteristics, such as age, sex, address, financial information etc., relevant Diagnoses, Medical Procedures and Medical Provisions provided thereto, as well as the patient's utilization of other resources. Most jurisdictions require the compilation of this type of information, and typically the health care provider employs the ICD coding system in compiling the Patient Record.

Patient Group Profile—statistical and financial profile detailing health resource usage for a Patient Group, as compiled from data obtained from a plurality of health care providers.

### DETAILED DESCRIPTION

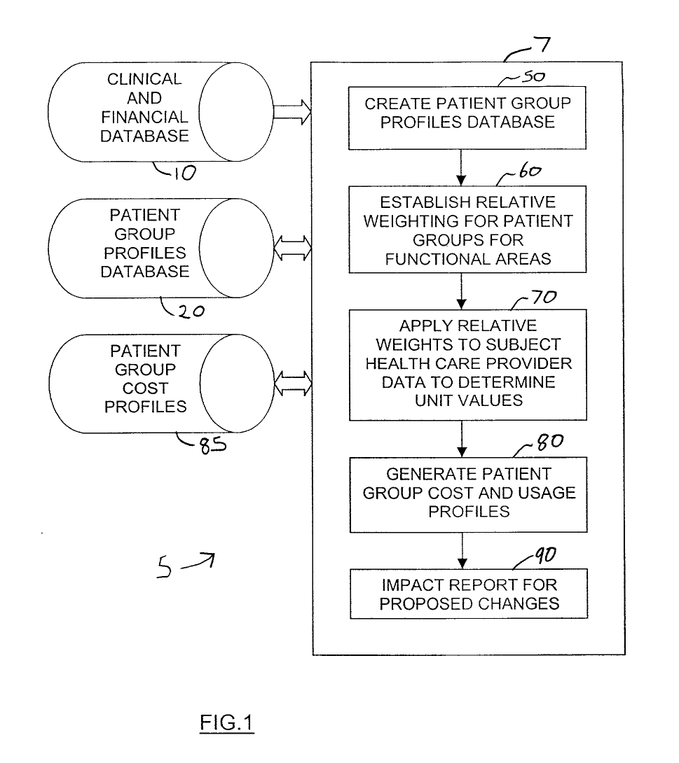

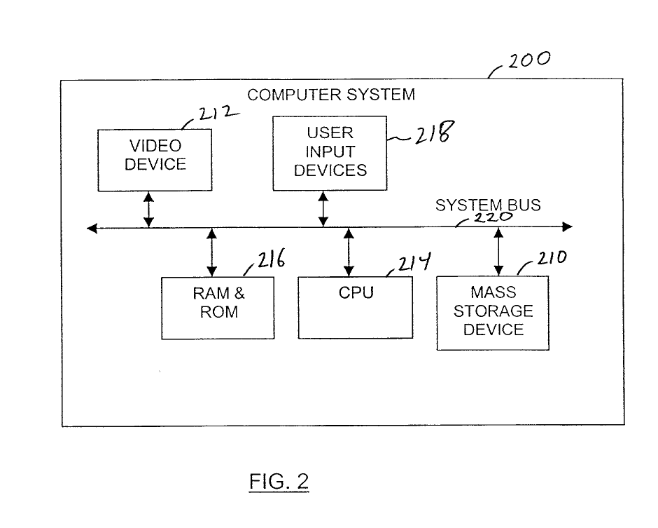

An overview of a case costing and resource profiling system in accordance with a preferred embodiment of the invention is indicated generally by reference numeral 5 in FIG. 1. In a preferred embodiment the system 5 includes databases 10, 20, and software 7, and is implemented using a suitably configured computer system 200, such as that shown in FIG. 2, having one or more mass storage means such as a hard drive 210 or laser disc drive for storing program instructions and databases, output devices such as a video device 212 and printer, a microprocessor 214, read only and random access memory 216 user input devices 218 such as a keyboard, voice input device, mouse, touch pad, and/or track ball and a system bus 220 interconnecting the previously mentioned components. The system could be carried out in a distributed manner using more than one computer system, in which case the plurality of computer systems could be connected by a network. The software 7, or some of the modules thereof, could be distributed as an electronic file on a recorded medium or could be transmitted as a signal. The computer system configurations described above are merely examples, and it will be appreciated upon review of the present description that a number of different computer system configurations could be used in the implementation of the present invention.

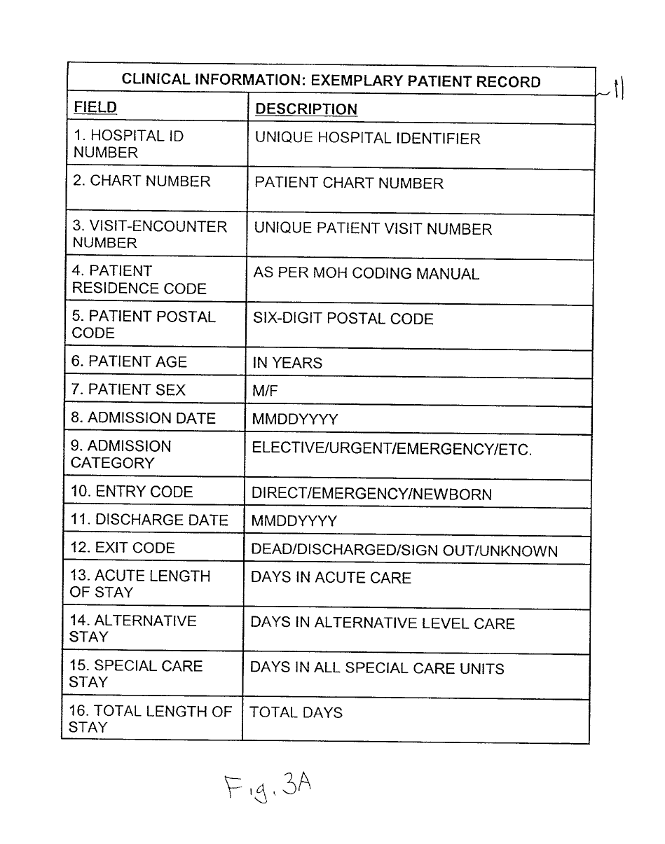

With reference to FIG. 1 the system of the present invention includes a health care provider clinical and financial database 10, which in a preferred embodiment is a digitized relational database that contains clinical data, financial data and statistical information collected in respect of a subject health care provider. The clinical and financial database 10 is stored in a location electronically accessible by computer system 200, for example, on mass storage device 210. The subject health care provider may be any health care organizational unit for which case costing and resource profiling is desired. For example, among other organizations, it could be a hospital, or a group of hospitals and other care facilities managed by a regional body, or a medical clinic. In terms of clinical data, the database 10 includes a Patient Record Composite data File (“PRCF”) which contains substantially all of the Patient Records for the subject health care provider. Systems for collecting and maintaining computerized databases of Patient Records are well known and commonly used by health care providers. Each Patient Record is compiled during a patient's visit or stay with the health care provider and is a record of the particulars of the stay or visit, such as the patient name, address, sex, age, as well as a record of the patient's diagnosis, medical procedures and length of stay. By way of example, FIGS. 3A and 3B show a table 11 detailing the various fields of an representative Patient Record. It will be appreciated that the data in the PRCF will vary from health care provider to health care provider.

As indicated in FIGS. 3A and 3B, the representative Patient Record may include an indication of days spent in acute care, days spent in alternative levels of care, days spent in all special care units, and minutes spent in the operating room. The Patient Record may also identify Primary Diagnosis, Secondary Diagnosis and Primary Procedure fields. Typically, ICD codes are used in these fields. These classification fields allow data for various case types to be extracted and analysed from the PRCF.

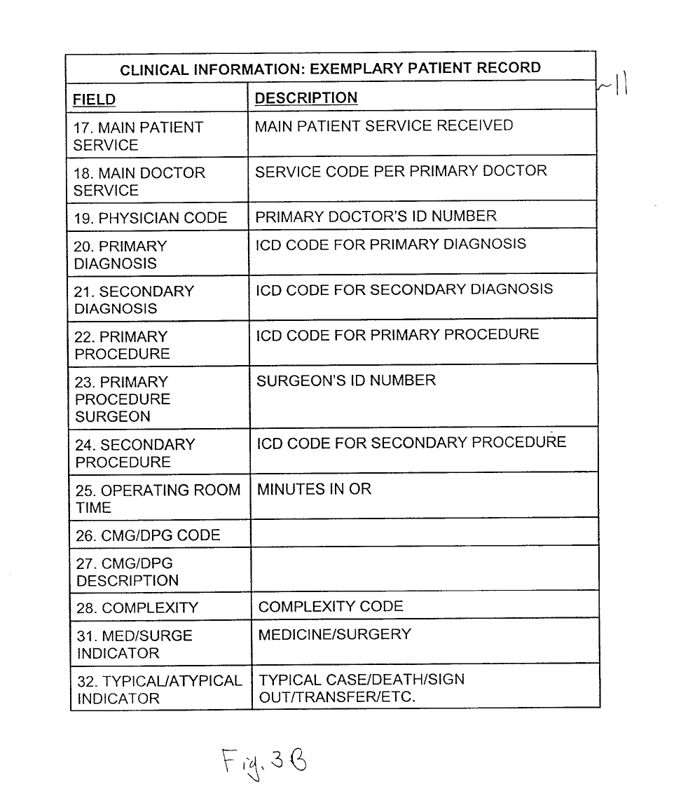

In terms of statistical and financial data, the clinical and financial database 10 includes information commonly collected by the health records, health information and accounting department and other departments of the subject health care provider for a predetermined time period, for example, a yearly reporting period. FIG. 4 illustrates a table 13 identifying the types of accounting information tracked by a health care provider such as a hospital. Preferably, the data tracks both the dollar cost and resource usage (i.e., quantity of units used) for a number of different Functional Areas for the subject reporting period. Each of the Functional Areas has a predetermined number of health resources associated with it. In the table 13, seven different Functional Areas are listed (namely, ward, special care units (ICU), operating room (OR), labs, diagnostic imaging, medical supplies, and pharmacy) and for each of the Functional Areas, a dollar amount and unit amount of the specific health resources that are used in the specific Functional Areas for the reporting period is provided. For each of the Functional Areas, the dollar values of variable direct labour cost, variable direct supply casts, total direct costs and total costs expended during a reporting period are preferably provided. If the data is available, such costs are preferably broken down by individual health resources in the Functional Areas (for example, b) specific procedure in diagnostic imagiong). Thus, the accounting information of database 10 provides financial and numerical unit totals for health resource consumption by various Functional Areas of the subject health care provider for at least one, and preferably several, reporting periods. The actual data tracked will vary according the subject health care provider costs will typically be broken down to the level normally collected by the subject health care provider. For example, some health care providers only track the total costs in the x-ray department and the total number of tests. Other health care providers may track detailed information about the number and cost of general x-rays, mammograms, etc. The system of the present invention is preferably configured to accommodate the actual level of real data available from the subject health care provider so that if the subject health provider does collect detailed data, they don't lose the advantage of that detail. Although seven Functional Areas are illustrated in the presently described embodiment, different health care providers will have different numbers of Functional Areas for which the track data. For example, some health care provider may have five, while some may have 30 or more Functional Areas.

In addition to having dollar and unit usage totals for the Functional Areas, the database 10 will preferably have dollar and unit usage totals for different categories of cases (defined as “Master Patient Groups” below) for the Functional Areas.

Referring again to FIG. 1, the system of the present invention also includes a Patient Group Profile database 20 that contains a number of researched profiles by Patient Group. The Patient Group Profile database 20 is preferably a digitized database stored in a location that is electronically accessible to computer system 200, for example, on mass storage device 210. A “Patient Group” is the generic term for a diagnostically related grouping of patients; for example all patients who had a simple appendectomy are in a Patient Group. Other classes of Patient Groups includes patients of a similar age group with a similar diagnosis. For example, another Patient group could comprise all patients with appendectomy and diabetes as a complicating diagnosis. In a statistical sense, a Patient Group is a cohort. The Patient Groups can be hierarchically organized, with higher level Patient Groups each containing a number of more specific Patient Groups.

For each of a plurality of different Patient Groups, the database 20 contains a list of the Functional Areas typically associated with the Patient Group, and further more, includes an indication of the actual amount (and in some cases, the cost) of the health resources that would normally be used within each of the Functional Areas for the average patient associated with each Patient Group. In one embodiment, higher level Patient Groups preferably relate generally to CMG's or DRG's, with lower level Patient Groups further broken into age groups, sex, and complexity levels. For example, a Patient Group Profile for a lower level Patient Group may be as determined as follows: For the Patient Group consisting of diagnostically-related groupings of patients with the diagnosis (A), the age grouping (B), sex (M or F), and the complexity level (C), the following amount of resources are used to treat the average patient in each of the following Functional Areas:

Ward (number ward days)

Special Care Unit (number of ICU days)

Operating Room (number of minutes)

Laboratories (number of tests performed)

Imaging (number of procedures)

Medical Supplies (number of units)

Pharmacy (number of units)

Thus, in one preferred embodiment, the Patient Group Profiles database contains a designation of the average unit usage per Functional Area per Patient Group.

In a preferred embodiment, the Patient Group Profiles database 20 is generated by a “Create Patient Group Profiles” module 50 from data obtained from numerous health care providers from various regions that use detailed per patient data tracking and case costing for the Functional Areas. The greater the number of health care providers from which data is obtained, generally the more statistically accurate the database 20 will be. For example, as noted above, some health care providers use extensive case costing systems in which each resource used by each patient is tracked. This detailed information from such health care providers is used to create a global, extremely detailed database of Patient Group Profiles including details about the health resources used by the average patients in such groups, and details about the average resource use in each of the Functional Areas.

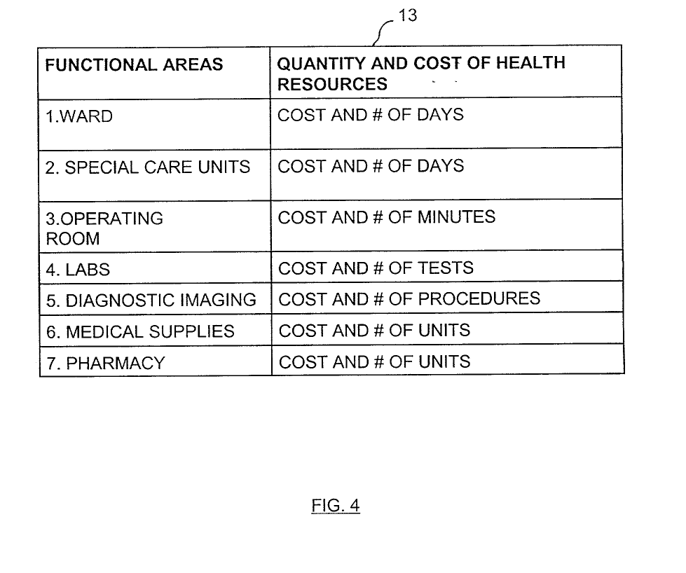

For further explanatory purposes, a flowchart illustrating a representative process used by the Patient Group Profiling module 50 to determine the Patient Group Profiles for Patient Groups pertaining to specific CMG code, (for example, an appendectomy) is shown in FIG. 5. As indicated in step 50-1, a database containing resource usage information for the subject Case Mix Group is compiled from case costing data obtained from a number of heath care providers 50-A, 50-B to 50-J, at least some of which keep more detailed case resource usage information than found in the subject health care provider database 10. The cases of the compiled CMG database are then analysed to determine the resolution that exists in respect of various possible lower level Patient Groups, for example age group, sex, complexity, ethnicity, and other possible demographic and clinical groupings (step 50-2). The Patient Groups are preferably established with consideration being given as well to the type of data available in the PRCF of the subject health care provider database 10. For example, if information on patient ethnic origin is included in database 10 and database 20, Patent Groups could be broken down to such a level, however if ethnic information was only available in database 20, then the Patient Groups would not be broken down to such level. Based on such analyses statistically valid cohorts (i.e. Patient Groups) are established. As part of establishing statistically valid Patient Groups, it is preferable to determine the level of detail available for health resource consumption analysis in respect of each Patient Group which requires a determination of the Functional Areas and associated health resources used in the treatment of the Patent Groups, and a determination of whether the data-base created in step 50-1 contains enough information to provide statistically valid health resource consumption information in respect of the specific health resources used in treating the Patient Group.

In one preferred embodiment, the Patient Groups are analysed for the presence or absence of use of a number of different possible health resources. For each pre-determined health resource, use is categorized accordingly to what percentage of cases within the Patient Group use the health resource and the average of such usage. Usage units are determined based on the workload statistics collected by the particular health providers 50-A, 50-B, and 50-J in respect of the health resources. For some health resources, data conversion to rationalize data from different care providers ma be required. For example X-ray Views, number of X-ray Visits, or number of Patient per hour are three methods of collating X-ray data. The choice of which measurement to use a “unit” will generally be made based on what is most desirable for the subject health care provider, which will typically be the measurement units that are found in the subject health care provider database 10.

Once the Patient Groups are established, data is extracted from the compiled database of step 50-1 to determine, for each of the Patient Groups, average amounts costs of health resources used to the extent that such data exists (step 50-3), the extracted averages being used to created a Patient Group Profile for each Patient Group to the highest level of detail available. For example, in a preferred embodiment, for each Patient Group, the Patient Group Profile contains the average units used for all the Functional Areas associated with the Patient Group. (It will be appreciated that a Functional Area is in effect a general health resource representing a grouping of specific health resources—for example, as ward day is representative of nursing hours, meals, linens, etc).

Referring once again to FIG. 1, the software 7 of the case costing and profiling system 5 includes a Relative Weighting Module module 60 Which uses the detailed Patient Group Profiles of database 20 to establish relative resource weightings for each of the Functional Areas for the Patint Groups associated with those Functional Areas. The relative resource weightings for Patient Groups are determined by comparing the relative average unit usage of the Functional Area for the Patient Groups that use the Functional Area.

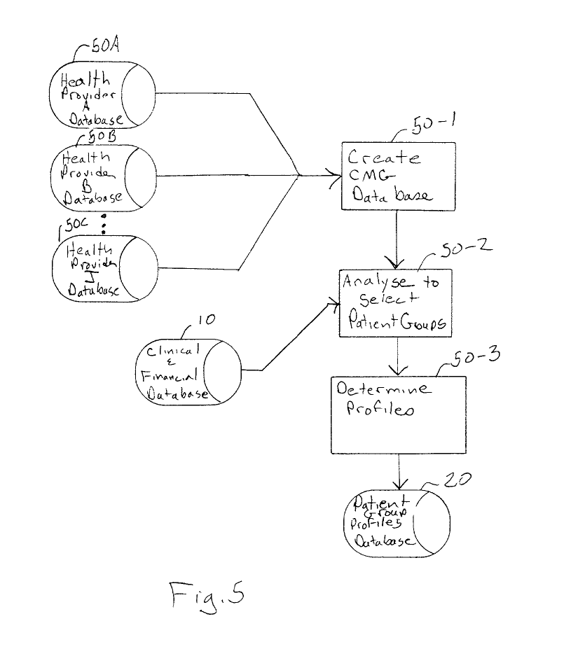

Although different algorithms can be used to establish the relative resource weightings, in one embodiment the relative resource weightings for the Functional Areas for the Patient Groups are determined using the procedure illustrated in the flowchart 60 of FIG. 6. In particular as indicated in step 60)-1, a relevant functional Area is selected. For the selected Functional Area, the Patient Group Profiles database 20 is scanned and a lowest average unit usage is determined by selecting the Patient Group having the lowest average unit usage (other than zero usage) of the Functional Area among the Patient Groups that use the Functional Area (Step 60-2). Then, an Functional Area relative weighting for each Patient Group that uses the resources of the selected functional Area is determined by dividing the selected lowest average unit usage for the Functional Area into the average unit usage for each Patient Group (Step 60-3) of the Functional Area. This creates a descending order of relative weighting for the Functional Area, with the Patient Group having the highest average unit usage of the functional area having the highest relative weighting and the Patient Group having the lowest average unit usage having a relative weighting of 1.0. The relative weightings are stored in a relative weightings database 62. As indicated in Step 60-4, once all of the relative weightings for the selected Functional Area are determined, the process of steps 60-1 to 60-3 is repeated for each of the Functional Areas associated with the subject health provider, with the result that a relative weighting is determined for each Patient Group for each Functional Area.

The determination of the relative weightings is based on research that has indicated that although actual costs and quantities of a particular resource used for a particular Patient Group from care provider to care provider may vary extensively, the actual ratio of a resource used for a particular Patient Group relative to use of the resource by other Patient Groups generally does not vary as widely. Thus creation of an relative weight for each Patient Group in a Functional Area allows data from several different care providers to be amalgamated to create fairly accurate weighting values for the resources used for each Patient Group.

The relative weighting module 60 is preferably implemented by suitably configured software executed on the computer system 12, with the relative weightings database 62 generated by such module being stored in a location electronically accessible to computer system 12. The relative weightings database 62 may, in a preferred embodiment, be a subset of Patient Group Profiles database 20)

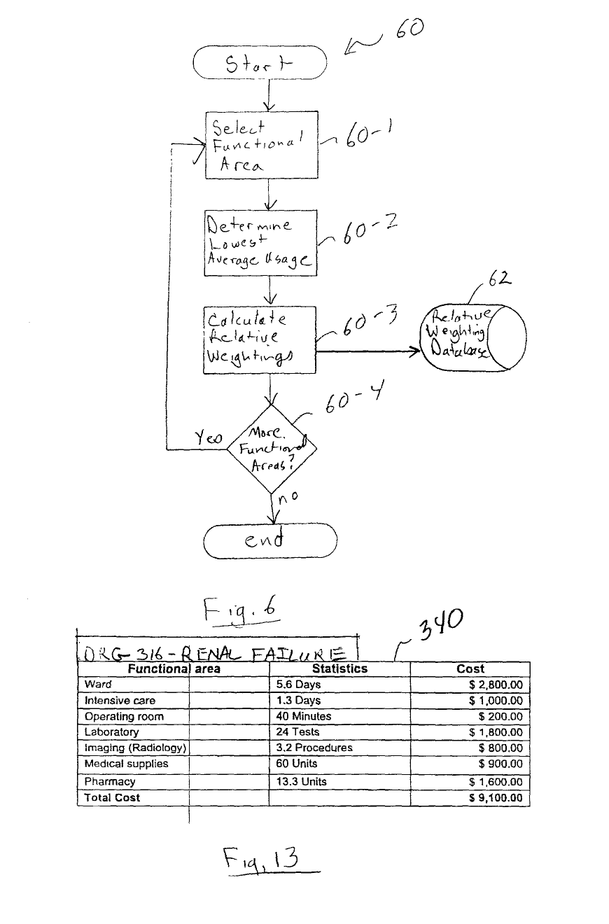

With reference again to FIG. 1, the software are 7 includes an application module 70 for applying the relative weightings that have been determined by module 60 to the actual Patient Group caseload data of the subject health care provider. FIG. 7 shows a flowchart that is illustrative of the operation of the application module 70 in accordance with preferred embodiments of the invention. In a preferred embodiment of the invention, as a preliminary step the application module 70 identifies by consulting the subject health care provider's clinical and financial database 10 a number of “Master Patient Groups”. Each Master Patient Group comprises a number of Patient Groups falling, within a category of cases for which the health care provider normally tracks total health resource consumption information for (such information being available in the database 10). For example, a Master Patient Group may consist of all Patient Groups that can be categorized as falling within the health care provider's Renal Program (for example, Patient Groups in the Renal Program will include, inter alia, renal failure and dialysis). Preferably the database 10 contains the information necessary to determine the number of cases per reporting period (for example, a year) of the subject health care provider for each of the Patient Groups falling within the Master Patient Group, the total health care provider budget for the reporting year for the Master Patient Group, and the total resource unit usage and/or budget for the Master Patient Group in respect of each of the Functional Areas for the reporting period. The Master Patient Groups can be hierarchal with higher level Master Patient Groups including a plurality of lower level Master Patient Groups. Preferably, the lowest level Master Patient Groups are selected to include the highest degree of resolution possible from the subject health care provider database 10. For example, in one preferred embodiment, a Master Patient Group is created for each group for which total consumption information is available in respect of the various Functional Areas. In effect, Master Patient Groups are broader cohorts that encompass generally more than one Patient Group, for which the subject health care provider has tracked information that can not be directly attributed to the individual Patient Groups that make up the Master Patient Group.

Once the Master Patient Groups have been determined, the relative weights of relative weighting database 62 are applied to the actual subject health care provider data to obtain resultant-weights based on the subject health care providers actual workload (step 70-2). In particular, for each Master Patient Group, a resultant weight in calculated for each of the Patient Groups making up the Master Patent Group for each Functional Area. The resultant weight (RW) for each Patient Group for each Functional Area is determined by the following equation:

RW(No. of Cases)×(RRW),

Where:

RW is the resultant weight for a Patient Group for a Functional Area;

No. of Cases is the number of cases falling within the Patient Group that the subject health provider recorded during the subject reporting period; and

RRW is the relative resource weight from relative weighting database 62 for the subject Patient Group for the subject Functional Area.

Once all of the resultant weights in respect of the Patient Groups within a Master Patient Group have been determined, then total resultant weights for each of the Functional Areas are calculated (step 70-3) by summing the calculated resultant weight for each of the Patient Groups for each of the Functional Areas. Upon completion of step 70-3, a total resultant weight representative of the actual consumption of resources by the Subject Health Care Provider for each Functional Area has been determined for a plurality of Patient Groups. As mentioned previously, the total actual unit usage and/or dollar budget is also known for each of the Functional Areas for each of the Master Patient Groups. Using this information, a statistical and dollar unit value for each relative weighting unit can be determined for each Functional Area on a Master Patient Group by Master Patient Group basis for the Subject Health Care provider (step 70-4) In particular, by dividing the actual total statistical unit usage of a Functional Area attributed to a Master Patient Group for the reporting period by the calculated total resultant weight for the Functional Area by a Master Patient Group, a statistical unit value (SUV) of a relative resource weighting unit can be determined. Similarly, by dividing the actual budgeted cost for a Functional Area attributed to a Master Patient Group by the calculated total resultant weight for the Functional Area by a Master Patient Group, a dollar unit value (DUV) of a relative resource weighting unit can be determined. Thus, at the completion of step 70-4, statistical and dollar unit values have been determined, on a Master Patient Group basis, for each of the Functional areas in respect of the relative weightings previously stored in relative weighting database 62. The calculated statistical and dollar unit values of the relative weightings can be stored in relative weighting database 62, or in another suitable database.

Once unit values of the relative weightings have been determined, case costing and profiling can be carried out in respect of the subject health care provider (Module 80). In particular, in the described embodiment, for each Patient Group (ie. case-type), a case cost profile can be generated for each Functional Area by multiplying the relative Sleight for the Patient Group for the Functional Area by the unit value determined in respect of that Patient Group for the Functional Area (in the presently described embodiment, all Patient Groups within a Master Patient Group share the same statistical and dollar unit values per Functional Area). This permits a level of cost detail and usage detail not available from the subject health care provider database 10 to be determined. It will thus be appreciated that the combined effect of modules 70 and 80 is to reconcile the subject health care provider information in accordance with the detailed case costing data available from third party health care providers, resulting in adjusted cost and statistical usage data for the subject health care provide. In some instances, the subject health care provider may actually have detailed cost data for some of the functional Areas by Patient Group, and in such cases, the actual data will be used in generating the case cost profile rather than the adjusted values.

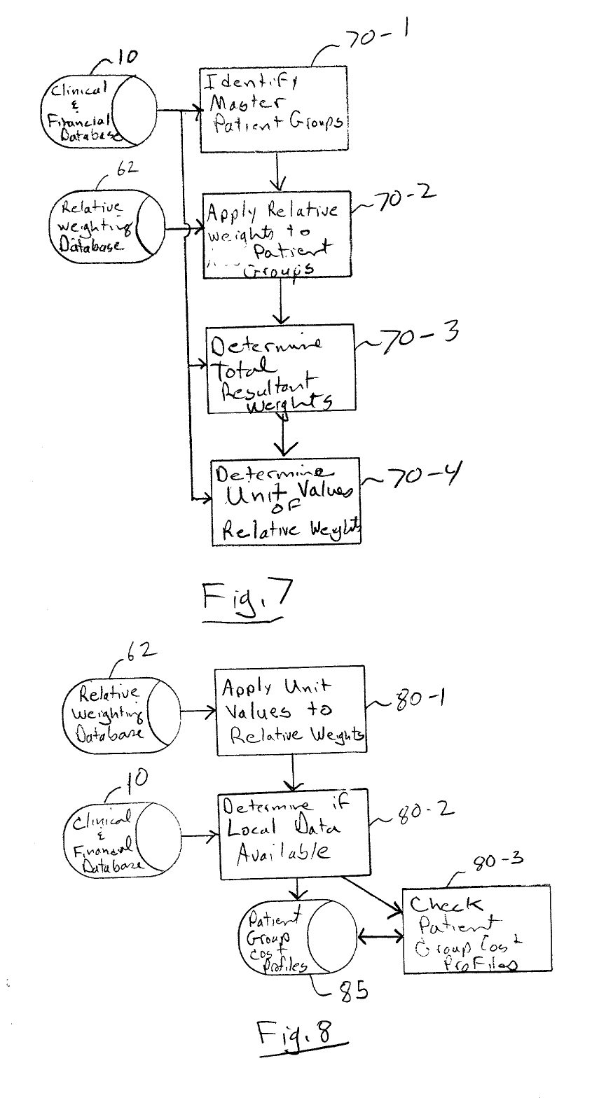

For further explanation, FIG. 8 is a flowchart of the process performed by the module 80 in accordance with one embodiment of the invention. As indicated in step 80-1, a Patient Group profile for the subject health care provider is determined by multiplying the relative resource weights that were calculated by module 60 by the corresponding statistical and dollar unit values that were determined by module 70, resulting in. In step 80-2, a check is performed to determined if the subject health care provide database 10 contains an actual tracked value for any of the values estimated in step 80-1. If so, the estimated values are replaced with the actual tracked values so that estimated values are only used when actual data is not available. The Patient Group cost profiles are the stored in a database 85, or output to a display or output device as desired.

The present invention provides virtual case costing through an optimal data method by using actual hard data from the subject health care provider when such data is available, and reconciling data from the subject health care provider using weighting factors that are based on a broad database of previous experience. It has been determined that such a methodology generally provides all acceptable level of accuracy without requiring a health care provider to purchase and maintain an extensive information technology system for tracking, on a per patient basis, every resource used by a patient. Thus a real and substantial result is achieved by the present invention.

In one preferred embodiment of the invention, the case cost profile module 80 is configured to check the accuracy of the generated profiles by adding up all the profile costs for each Master Patient Group and determining if the total profiles costs equal the total budget for the Master Patient Group (step 80-3).

In one preferred embodiment, the Patient Group Profiles created by module 80 are used in conjunction with a health care resource allocation system such as that described in U.S. Pat. No. 5,778,345 issued to the present inventor In this regard, the system 5 includes an Impact Report module 90 that is configured to, using modelling tools, take the resource workload for the health care provider and modify it to generate a new overall workload resource statistic based on certain allocation methods discussed in U.S. Pat. No. 5,778,345. which is hereby incorporated by reference. For example, a modified workload may result from projected changes in the population serviced by the subject health care provider. The module 90 is further configured to apply the health provider Patient Group Profiles determined by module 80 to the modified workload so that the detailed impact on each health provider, program, specialty hospital, geographic area etc., can be viewed. Using such information, the module 80 is configured to create a new provider/service specific budget, and create a next resource needs inventory for the subject health care provider. The new resource inventories and budgets are calculated using additive (roll-up) methods and based on the specific organizational structure of the subject health care provider. Resources can be reallocated based on the difference between the base resource inventory and the new resource inventory. The impact or projected and actual changes can be measured and accurate, detailed cost estimates of changes can be prepared to support decisions. Managers and planners can make resource allocation decisions with accurate, detailed resource and financial information.

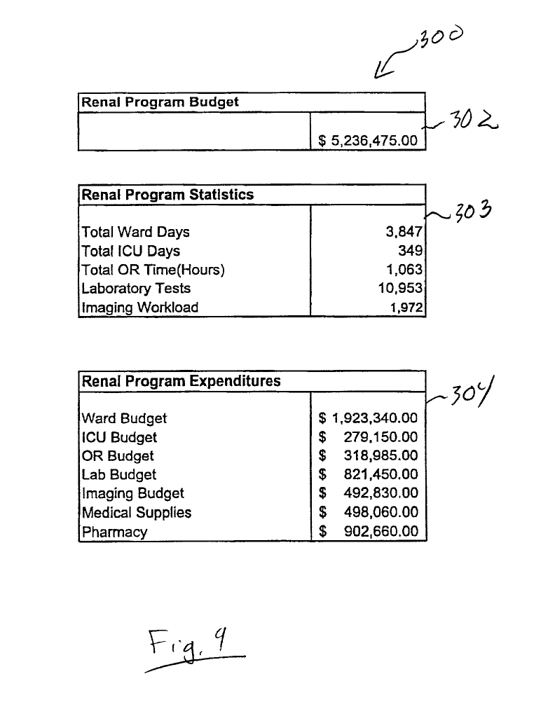

An overview of the method and system of the present invention having been provided above, one example of its operation in which researched profiles based on third party data are used to analyse resource needs and provide case costing in respect of a subject health care provider will now be described. In the following example, case costing and resource profiling is illustrated in respect of a Master Patient Group consisting of all Patient Groups that fall with the subject health care provider's “Renal Program”. FIG. 9 shows a table 300 that is illustrative of the detail of information that is tracked by the subject health care provider and therefore available from the subject heath care provider's clinical and financial database 10 for the renal program Master Patient Group, including a total annual renal program budget amount 302 ($5,236,475), annual renal program statistics 303 by Functional Area, and annual renal program expenditures 304 by Functional Area. Heath care providers often collect the information shown in FIG. 9 for reporting to senior management and/or government.

FIG. 10 shows a further table 310 of clinical information that can be obtained from the subject health care provider's database 10 for the annual period, including an identification of each of the Patient Groups that make of the renal program Master Patient Group. In the table 310, the different Patient Groups are identified by DRG number column 312 and corresponding DRG description column 314. For each of the Patient Groups, the table 310 includes a column 316 that identifies the number of cases falling with each Patient Group in the subject annual period, and a column 318 that identifies the average length of stay (ALOS) associated per case per Patient Group.

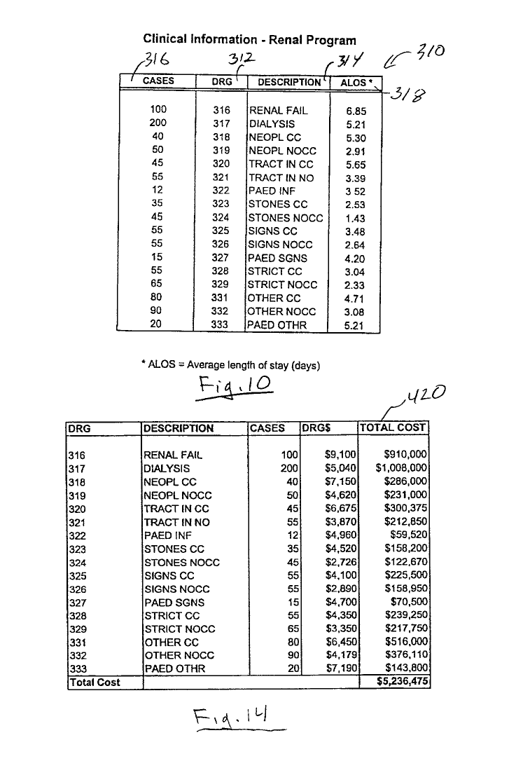

As indicated above, the software 7 is configured, through modules 50 and 60, to create, based on detailed third party information, a relative weighting database 62 of weights that correspond to relative usage of a Functional Area for each Patient Group. For the present example table 400 of FIG. 11 identifies the relative weightings that have been determined, for each Functional Area for the DRG Patient Groups associated with the Renal Program. For example, the Patient Group renal failure (DRG 316) has a relative weighting of 4.32 for the Functional Area Pharmacy, whereas the Patient Group renal strictures, no complications (DRG 329) has a relative weighting of 1.05 for the Functional Area Pharmacy. In other words, data obtained from third party health care providers that collect detailed information indicates that, on average, approximately four times more drugs are used on a renal failure patient than on a renal strictures, no complications, patient. Interestingly, if resource weighting is calculated using a traditional method based on average length of stay (ALOS) data from the subject health care provider, the result would he inaccurate as the length of stay for DRG 316 is only three times that for DRG 329

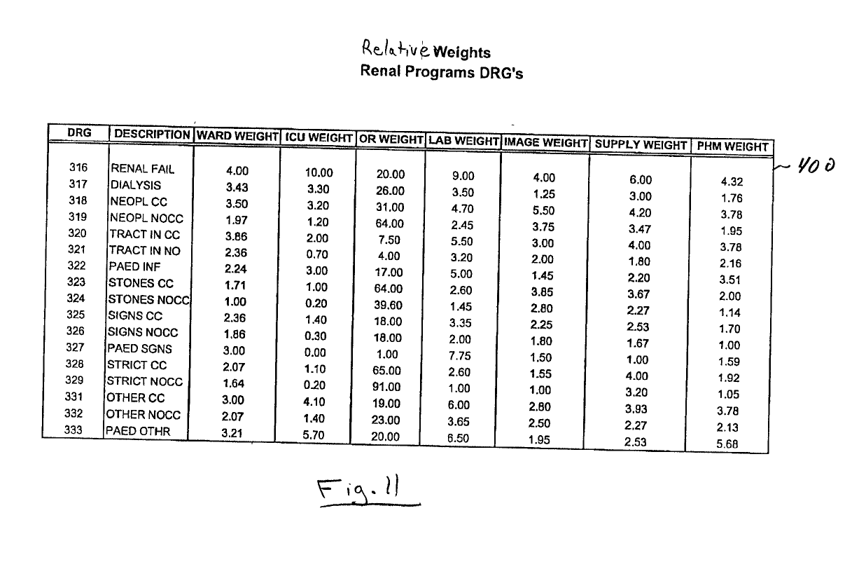

With reference to FIG. 1 and FIG. 7, as indicated above the software 7 is configured to apply the relative weights calculated by module 60 to the subject health care provider data in order to determine unit values for the relative weightings. As indicated in step 70-2, the relative weights are multiplied by the caseload data for each of the Patient Groups in order to determine Resultant Weights per Patient Group per Functional Area. The table 410 of FIG. 12 illustrates the Resultant Weights calculated for the Patient Groups falling with the renal program Master Patient Group For example, the number of cases falling within renal failure Patient Group DRG 316 for the subject reporting year for the subject health care provider, namely 100, is multiplied by the relative weight for that Patient Group for the Functional Area ward, namely 4.00 (from table 400 of FIG. 1), to generate a resultant weight of 400.00 for the renal failure Patient Group DRG 316 for the Functional Area ward. Using this procedure, Resultant Weights are calculated for all of the Patient Groups for all of the Functional Areas. As indicated in step 70-3, the total resultant weights for each of the Functional Areas are then determined for each Master Patient Group by summing the resultant weights that have been calculated for the Patient Groups that make up the Master Patient Group. Total Weight row 412 of table 410 illustrates the total resultant weights per Functional Area for the renal program Master Patient Group. As indicated in step 70-4, statistical and dollar unit values for the relative weightings can then be determined on a Functional Area by Functional Area basis for the each Master Patient group by dividing the actual subject health care provider's statistical and dollar totals for the Functional Areas by the total resultant weights. For example, row 414 illustrates the dollar unit values of a single unit of relative weighting for each of the Functional Areas in the present example. The dollar relative weighting unit value of $700 for the shard Functional Area has been determined by dividing the annual renal program ward budget of $1,923,340 from table 300 of FIG. 9 by the total resultant ward weight of 2747.63. The dollar relative weighting unit values for the remaining Functional Areas are determined in a similar manner, so that dollar unit values are known for each of the functional Areas for the Master Patient Group.

Similarly, statistical unit values are also calculated, data permitting for each of the relative weighting values on a Functional Area by Functional Area basis. Row 416 illustrates such unit values for the renal program Master Patient Group. The shard Functional Area relative weighting unit value of 1.4 days has been determined by dividing the total annual renal program ward days of 3.847 (from FIG. 9) by the total renal program resultant weight of 2747.63. Statistical relative weighting unit values of 0.13 days, 2 minutes, 2.67 tests and 0.8 procedures have been similarly calculated for the Functional Areas Special Care Unit (ICU), Operating Room (OR), Laboratory, and Imaging, respectively.

The process of determining dollar and statistical relative weight unit values functions to reconcile the third party statistical data with the available cost and statistical data of the subject health care provider.

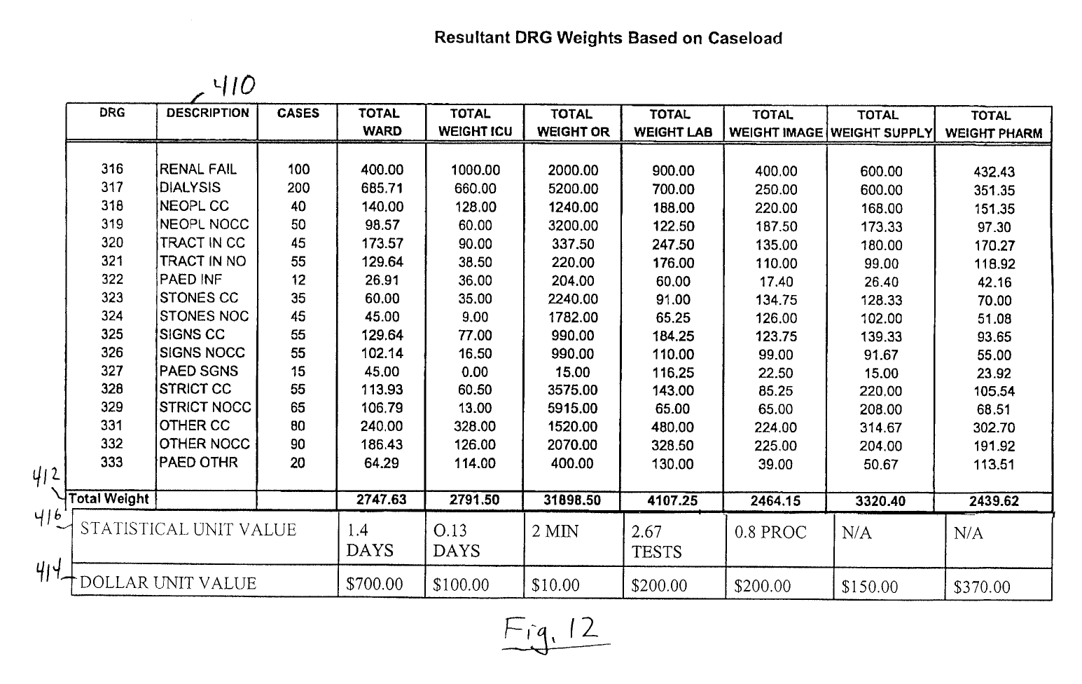

With reference to FIGS. 1 and 8, once the dollar and statistical relative weight unit values have been calculated, cost and resource profiling can be performed for each of the Patient Groups by Functional Area. FIG. 13 shows a table 340 that shows a calculated cost and resource profile for the Patient Group DRG316-renal failure. In the table 340, an average ward usage for a renal failure case type has been estimated to be 5.6 days, which has been determined by multiplying the relative resource weight for the ward Functional Area for the renal failure DRG316 Patient Group, namely 4.00 (from table 400) by the statistical relative resource weight unit value of 1.4 days (from table 410) that was determined for the renal program Master Patient Group for the ward Functional Area. Similarly, the following average unit usages are estimated for the renal failure Patient Group in respect of the following wards: Special Care Unit—1.3 days (relative resource weight (RRW) of 10.0×RRW statistical unit value (SUV) of 0.13 days), Operating Room—40 minutes (RRW of 20.00×SUV of 2 minutes): laboratory—24 tests (RRW of 9.00×SUV of 267 tests), and Imaging —3.2 procedures (RRW of 4.00×SUV of 0.8). With respect to Medical Supplies and Surgery, the respective average values of 60 units and 13.3 units ire, in one preferred embodiment the average values that were determined based on the third part), health care providers. This is because, in the illustrates example, no total consumption statistics for medical supplies or pharmacy is available from the subject health care provider.

Using the dollar unit values (DUV) calculated in table 410 for the renal program Master Patient Group, and the relative resource weights (RRW) per Functional Area from table 400, the average case cost per Functional Area for the Patient Group DRG316 renal failure is estimated to be as follows: Ward—$2.800 (RRW of 4.00×DUV of $700); Special Care Unit—$1,000 (RRW of 10.0×DUV of $100); Operating Room—$200 (RRW of 20.00×DUV of $10); Laboratory—$1,800 (RRW of 9.00×DUV of $200); Imaging—$800 (RRW of 4.00×DUV of $200); Medical Supplies $900 (RRW of 6.00×DUV of $150), and Pharmacy—$1600 (RRW of 4.32×DUV of $370). A total average cost of $9,100 per patient for the renal failure Patient Group is determined by summing the above dollar values together.

In a similar manner, case cost and statistical usage profiles can be estimated for all Patient Groups of the subject health care provider.

As mentioned above, a further reconciliation is performed (step 802) to determine if any of the calculated estimated dollar or statistical values for any Patient Groups can be replaced with actual hard data from the health care provider database 10. For example, for it may be possible that the subject health care provider is conducing a study in its imaging department that requires it to collect usage and cost statistics for the Patient Group DRG315 renal failure for the imaging Functional Area. In such a case, the presence of the actual data would be detected, and the estimated data replaced with the actual data. This provides an optimal degree of accuracy.

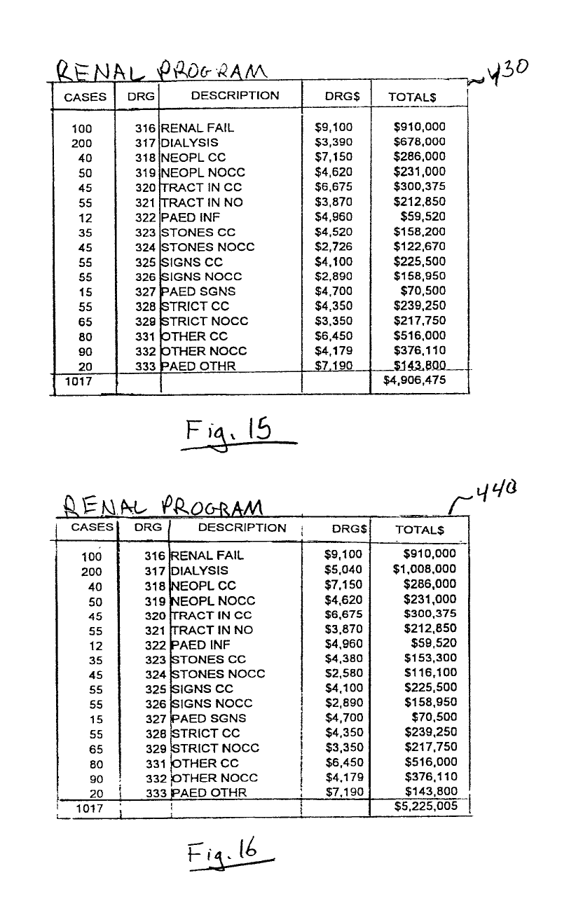

The calculated case cost and statistical usage profiles generated by module 80 are preferably stored in a Patient Group Cost Profiles database 85. As noted above, a final check to ensure that the software 7 has correctly analysed the available data, in step 80-3, the profiled costs for each Master Patient Group are summed to determine if the total profiles costs equal the total budget for the Master Patient Group. In the present renal program example, step 80-3 is illustrated through table 420 of FIG. 14. The column labelled “DRG$” contains the average total dollar cost per corresponding Patient Group, as estimated b) Module 80. The column labelled “Cases” identifies the number of cases occurring in each of the corresponding Patient Groups during the period of interest. By multiplying the average total dollar costs by the number of respective cases, a total cost per Patient Group for the period can be determined and by summing the total costs for all the Patient Groups in a Master Patient Group, a total cost for the Master Patient Group for the subject health care provider for the reporting period can be determined. This calculated total ($5,236,475 in the present example) should and does equal the total budget for the renal program Master Patient Group (see table 300 of FIG. 9). If the calculated total and actual budget did not match it would be indicative of an error that should be investigated.

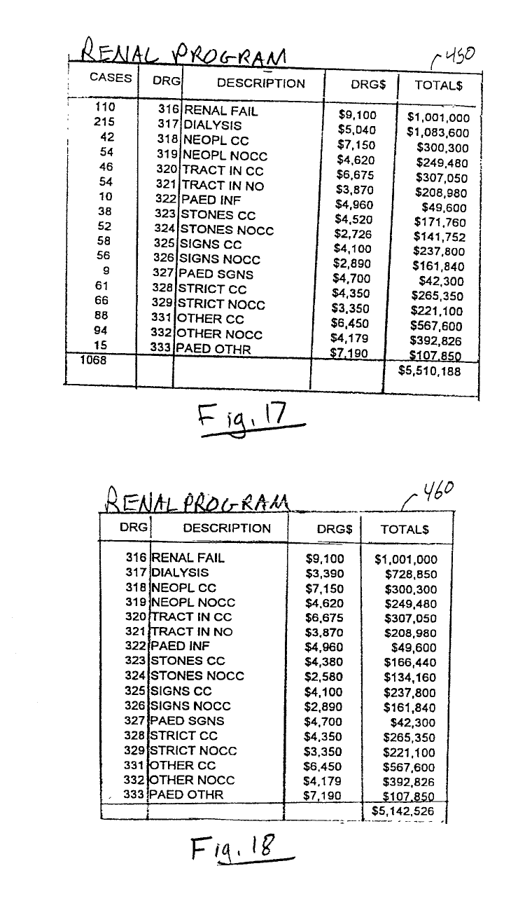

As indicated above, in one preferred embodiment of the invention, the soft are 7 includes an impact report module 90 for modifying the Patient Group cost profiles to reflect the impact of possible changes that may impact the subject health care provider. FIGS. 15 through 18 illustrate examples of the operation of the impact report module 90. FIG. 15 shows a table 430 that illustrates the impact of reducing the length of stay in dialysis (DRG 317) to a 1.5 day bench mark. Compared with the determined profile data shown in table 420 of FIG. 14, even though the case volume is the same, the average case cost for DRG 317 reduces from $5,040.00 to $3,390,000.00(with a corresponding total cost for DRG 317 for the reporting period (Based on total number of cases of 200) dropping from $1,008,000.00 to $6,780,000.00. As indicated in the bottom of the totals Column of table 430, such change results in a total renal program budget reduction from $5,236,475.00 to $4,906,475.00.

FIG. 16 illustrates a table 440 showing the impact of a reduction in time in the operating room due to new technology for DRG's 323 (stones with complications) and 324 (stones without complications). As can be seen by comparing table 440 of FIG. 16 with table 420 of FIG. 14, the change in case and overall reporting period cost is illustrated. Although FIGS. 15 and 16 show the reductions in cost that can result in meeting a bench mark target (FIG. 15) and introducing a proposed new technology (FIG. 16), the methods of the present invention could also be used to show changes in per unit and total unit consumption in respect of the various Functional Areas for such changes. Changes in the resources used within the Functional Areas could also be illustrated. For example, reductions in per unit usage due to meeting the 1.5 day bench mark could be equated with a reduction in beds required, Registered Nurse time required, etc.

FIG. 17 illustrates the changes in total costs due to projected increased case loads as a result of demographic changes in the community and other factors. In the simplified table 450 of FIG. 17, only the number of cases for each of the different DRG grouping is changed for the subject health care provider.

FIG. 18 illustrates a table 460 showing an example of a complex impact assessment. In this example, the per case and total costs are shown for a model in which the length of stay in dialysis is reduced to the bench mark of 1.5 days (example FIG. 15), the OR time is reduced in DRG's 323 and 324 due to a new technology (example FIG. 16); and changes in case load due to demographic changes (the example of FIG. 17). Accordingly, the present invention allows hospital administrators and other decision makers to forecast the cost and usage impact that proposed and pending changes will have on the subject health care provider environment.

It will thus be appreciated that the present invention permits detailed case costing and statistical profiling to be carried out by using data from both third parties and the subject health care provider. Although the in the embodiments described above, profiling and costing is performed at the Functional Area level, the methods taught above could also be used to break costs and usage estimations down to lower resource levels, for example, resources such as meals, health care professionals, and linens could be detailed for the Ward and ICU Functional Areas and the different types of imaging detailed for the imaging Functional Area.

It will be appreciated by persons skilled in the art that the present invention is not limited by what has been particularly shown and described herein. Rather, the scope of the present invention is defined by the claims which follow.

I claim:

1. A method for determining resource consumption information for a subject health care provider using resource consumption information of at least one other health care provider comprising:
(a) determining based on information obtained from the at least one other health care provider, a relative resource weight for a health care resource for a patient group based on consumption of the health care resource by the patient group relative to consumption of the health care resource by a sample group; and
(b) determining, for the subject health care provider, an estimated consumption of the health care resource for the patient group by adjusting consumption information of the subject health care provider based on the determined relative resource weight.

2. The method of claim 1 wherein in step (a) relative resource weights for the health care resource are determined for a plurality of patient groups, the sample group including the plurality of patient groups, and in step (b) an estimated consumption of the health care resource is determined for at least some of the plurality of patient groups.

3. The method of claim 2 including a step of determining if actual consumption information about the health care resource by at least some of the plurality of patient groups is available from the subject health care provider, and if so using the actual consumption information rather than using estimated consumption information as resource consumption information for the health care resource for the patient groups for which actual consumption information is available.

4. The method of claim 2 including
determining for the subject health care provider for a reporting period a resultant total weight for use of the health care resource by a master patient group comprising a plurality of patient groups by (i) determining for each of the patient groups falling with the master patient group a product of the relative resource weight for the patient group and the number of patient group cases treated by the subject health care provider during the reporting period, and (ii) summing all of the determined products for the master patient group; and
determining a per unit value for the relative resource weights for the patient groups falling within the master patient group by dividing the resultant total weight into a known total unit consumption of the health care resource by the subject health care provider during the reporting period;
said step (b) including multiplying the relative resource weights for at least some of the patient groups by the per unit value to determine an estimated unit consumption for the at least some patient groups.

5. The method of claim 4 wherein said step (a) includes selecting from the sample group the patient group having a lowest average non zero usage of the health care resource, and the relative resource weight for each of the patient groups is based on a ratio of an average usage of the health care resource in respect of the patient group to the lowest average usage.

6. The method of claim 2 wherein each patient group includes a plurality of diagnostically related cases, and in step (a) the relative resource weights are based on information obtained from a plurality of health care providers.

7. The method of claim 1 wherein an estimated per patient group case average usage and average cost is determined for the health care resource for the subject health care provider.

8. The method of claim 1 wherein the health care resource is a functional area that includes a plurality of resources.

9. The method of claim 1 including a step of determining the impact of a change on the subject health care provider by predicting future consumption of the health care resource based on the impact of the change on the estimated consumption of the health care resource.

10. The method of claim 1 including a step of projecting a future number of occurrences of cases falling within the patient group at the subject health care provider and predicting future consumption of the health care resource based on the projected number of occurrences and the estimated consumption of the health care resource.

11. A health care resource profiling system comprising:
a subject health care provider database containing information quantifying a total use of a health care resource by a master patient group at a subject health care provider during a predefined time period the master patient group comprising a plurality of case types;
a third party profile database containing information about the use of the health care resource in respect of the case types at a plurality of third party health care providers;
relative weighting means for determining, based on information in the third party profiles database, case type relative resource weights for each of the case types, each case type relative weight being representative of the average consumption of the health care resource by each of the respective case types relative to consumption of the health care resource by a sample group; and
profile generating means for generating a resource use profile for the subject health care provider for the health care resource, the use profile including estimated consumption values of the heath care resource for at least some or the case types, the estimated consumption values being determined by adjusting the information quantifying the total use of the health care resource by the master patient group at the subject health care provider based on the case type relative resource weights.

12. The health resource profiling system of claim 11 wherein the profile generating means is configured to determine if consumption values for the health care resource are available for at least some of the case types from the subject health care provider database and if so, include the available consumption values in the use profile.

13. The health resource profiling system of claim 11 wherein at least some of the estimated consumption values include an average monetary value expended on the health care resource for a patient falling within the respective case type.

14. The health resource profiling system of claim 11 wherein at least some of the estimated consumption values include an average unit usage of the health care resource for a patient falling within the respective case type.

15. The health care resource profiling system of claim 11 wherein the relative weighting means is configured to select from the sample group the case type for which an average consumption of the health care resource is lowest among the case types using the health care resource, the relative weights per case type being determined by dividing an average consumption per case type by the average consumption of the selected lowest average case type.

16. The health care resource profiling system of claim 15 including:
means for determining for the subject health care provider for tile predefined time period a resultant total weight the health care resources by (i) determining for each of the case types falling Within the master patient group a product of the case type relative resource weight for the case type and the number of occurrence of the case type at the subject health care provider during the predefined period, and (ii) summing all of the determined products for the master patient group; and
means for determining a per unit value for the relative resource weights for the case types falling within the master patient group by dividing the resultant total weight into a known total unit consumption of the health care resource by the subject health care provider during the predefined period;
wherein said profile generating means is configured to multiply the case type relative resource weights for at least some of the case types by the determined per unit value to determine an estimated unit consumption for the at least some case types.

17. The health resource profiling system of claim 11 including:
projected profiling means for estimating, based on projected population changes in an area serviced by the subject health care provider, a future incident rate for at least some of the case types for the subject health care provider, and generating projected resource consumption information for the subject health care provider based on the future incident rate and the estimated consumption values for the corresponding case types.

18. A computer program product including a medium carrying program code means for determining resource consumption information for a subject health care provider using resource consumption information of at least one other health care provider, the program code means including:
program code means for determining, based on information obtained from the at least one other health care provider, a relative resource weight for a health carte resource for a patient group based on consumption of the health care resource b the patient group relative to consumption of the health care resource by a sample group, and
program code means for determining for the subject health care provider, an estimated consumption of the health care resource for the patient group by adjusting consumption information of the subject health care provider based on the determined relative resource weight.

19. The computer program product of claim 18 wherein the medium is selected from the group consisting of a computer recordable medium and a transmitted signal.

20. The computer program product of claim 18 including program code means for determining if actual consumption information about the health care resource by at least some of the plurality of patient groups is available from the subject health care provider and if so using the actual consumption information rather than using estimated consumption information as resource consumption information for health care resource for the patient groups for which the actual consumption information is available.
